(19) United States
(12) Patent Application Publication
(10) Pub. No.: US 2024/0078461 A1
(43) Pub. Date: Mar. 7, 2024

(54) GEOMETRIC PHASE GATE USING A MAGNETIC FIELD GRADIENT

(71) Applicant: Quantinuum LLC, Broomfield, CO (US)

(72) Inventor: Robert Tyler Sutherland, San Antonio, TX (US)

(21) Appl. No.: 18/449,967

(22) Filed: Aug. 15, 2023

Related U.S. Application Data
(60) Provisional application No. 63/514,621, filed on Jul. 20, 2023.
(60) Provisional application No. 63/374,811, filed on Sep. 7, 2022.

(51) Int. Cl. G06N 10/40

(52) U.S. Cl. CPC G06N 10/40

(57) ABSTRACT

A controller of a quantum system causes a geometric phase gate to be performed on two or more qubits by causing two or more qubits of the quantum system to experience a (near field and/or non-radiating) magnetic field gradient; and, responsive to determining that a gate time period has elapsed since the two or more qubits of the quantum system started to experience the magnetic field gradient, causing the two or more qubits to no longer experience the magnetic field gradient. The entanglement of the two or more qubits corresponding to the performance of the gate is enacted, mediated, and/or caused by the magnetic field gradient.

### CROSS-REFERENCE TO RELATED APPLICATIONS

This application claims priority to U.S. Application No. 63/374,811, filed Sep. 7, 2022, and U.S. Application No. 63/514,621, filed Jul. 20, 2023, the contents of which are incorporated herein by reference in their entireties.

### TECHNICAL FIELD

Various embodiments relate to a quantum logic gate using a magnetic field gradient. Various embodiments relate to a quantum logic gate that uses magnetic field gradients to enact entanglement between quantum objects.

### BACKGROUND

Quantum computing uses quantum interactions to perform quantum computations. An example quantum interaction is the performance of a quantum logic gate on a pair of qubits. For example, a quantum logic gate may be used to entangle two qubits. Conventionally, performance of a quantum logic gates includes the application of laser beams or microwaves on the two qubits being gated together. However, the laser beams can lead to photon scattering and/or introduce phase noise during the performance of conventional quantum logic gates, leading to reduced gate fidelity. Microwaves are sensitive to motional errors and require the qubit to be cooled to the motional ground state. Through applied effort, ingenuity, and innovation many deficiencies of such conventional quantum logic gates have been solved by developing solutions that are structured in accordance with the embodiments of the present invention, many examples of which are described in detail herein.

### BRIEF SUMMARY OF EXAMPLE EMBODIMENTS

Example embodiments provide methods for enacting a quantum logic gate that uses a (near field) magnetic field gradient to entangle two or more qubits, systems configured for performing such quantum logic gates, and/or the like. In various embodiments, the quantum logic gate does not use any radiating fields (e.g., laser beam, microwave signal, and/or the like) to cause the entanglement of the two or more qubits. Rather the entanglement of two or more qubits is enacted, mediated, and/or caused by a (near field) magnetic field gradient.

In various embodiments, performing the quantum logic gate comprises causing two or more qubits to experience a (near field) magnetic field gradient. After and/or responsive to determining that a gate time period has elapsed since the two or more qubits starting experiencing the magnetic field gradient, the two or more qubits are caused to no longer experience the magnetic field gradient.

For example, in an example embodiment, performing the quantum logic gate comprises controlling the operation of a confinement apparatus confining two or more quantum objects to cause the two or more quantum objects to be transported into a magnetic field gradient zone that is defined by a confinement apparatus and a magnetic field gradient source (e.g., a permanent magnet, permanent magnet array, electromagnet, electromagnet array, a combined array of permanent and electromagnets, and/or the like). While the two or more qubits are disposed within the magnetic field gradient zone, they experience a (near field) magnetic field gradient. After and/or responsive to the two or more qubits being disposed in the magnetic field gradient zone for a gate time period, the two or more qubits are transported out of the magnetic field gradient zone. In an example embodiment, the gate time period is determined at least in part based on an amount of time it takes for the magnetic field gradient to enact, mediate, and/or cause an entanglement of the quantum states of the two or more quantum objects.

In another example embodiment, the two or more qubits are transported into the magnetic field gradient zone while in a generally magnetic-field-insensitive quantum state or superposition of generally magnetic-field-insensitive states. The generally magnetic-field-insensitive quantum states are then mapped and/or coupled to (e.g., via one or more single qubit gates) respective magnetic-field-sensitive quantum states, such that the two or more qubits experience the (near field) magnetic field gradient present in the magnetic field gradient zone. After and/or responsive to the two or more qubits experiencing the (near field) magnetic field of the magnetic field gradient zone for a gate time period, the quantum states of the two or more qubits are mapped or coupled back to respective magnetic-field-insensitive quantum states.

According to one aspect, a method for performing a geometric phase gate is provided. In an example embodiment, the method comprises controlling, by a controller, operation of a confinement apparatus to cause two or more quantum objects confined by the confinement apparatus to be transported into a magnetic field gradient zone of the confinement apparatus. The two or more quantum objects experience a (near field) magnetic field gradient while disposed in the magnetic field gradient zone. The method further comprises, responsive to determining that a gate time period has elapsed with at least one of (a) the two or more quantum objects disposed within the magnetic field gradient zone or (b) the two or more quantum objects experiencing the magnetic field gradient, controlling, by the controller, operation of the confinement apparatus to cause the two or more quantum objects to stop experiencing the (near field) magnetic field gradient.

In an example embodiment, the two or more quantum objects are entangled within the magnetic field gradient zone during the gate time period without use of any radiating fields to enact/mediate entanglement of the two or more quantum objects.

In an example embodiment, the (near field) magnetic field gradient enacts/mediates entanglement of the two or more quantum objects within the magnetic field gradient zone.

In an example embodiment, the gate time period is determined based at least in part on an amount of time it takes for the (near field) magnetic field gradient to mediate/enact/cause the entanglement of the two or more quantum objects.

In an example embodiment, the method further comprises, prior to transporting the two or more quantum objects into the magnetic field gradient zone, causing respective quantum states of the two or more quantum objects to be evolved to respective gate subspace states.

In an example embodiment, the respective quantum states are evolved out of a memory subspace and into a gate subspace, wherein the respective gate subspace states are respective states of the gate subspace.

In an example embodiment, the memory subspace comprises two or more memory states that are each a respective clock state and the gate subspace comprises two or more gate subspace states that are each Zeeman states.

In an example embodiment, evolving the respective quantum states to the respective gate subspace states comprises causing a manipulation signal characterized by a frequency that is substantially resonant with the frequency difference between at least one memory subspace state and a corresponding gate subspace state to be incident on at least one of the two or more quantum objects.

In an example embodiment, the method further comprises, after determining that a gate time period has elapsed, transporting the two or more quantum objects out of the magnetic field gradient zone, and evolving the respective quantum states of the two or more quantum objects from the gate subspace to respective memory states.

In an example embodiment, evolving the respective quantum states of the two or more quantum objects from the gate subspace to respective memory states comprises causing a manipulation signal characterized by a frequency that is substantially resonant with the frequency difference between at least one memory subspace state and a corresponding gate subspace state to be incident on at least one of the two or more quantum objects.

In an example embodiment, the method further comprises performing one or more dynamic decoupling sequences on at least one quantum object of the two or more quantum objects between an initiation of the gate time period and a completion of the gate time period.

In an example embodiment, performing the one or more dynamic decoupling sequences on the at least one quantum objects of the two or more quantum objects comprises causing a dynamic decoupling manipulation signal to be incident on the at least one quantum object.

In an example embodiment, the at least one quantum object is transported out of the magnetic field gradient zone, the dynamic decoupling manipulation signal is incident on the at least one quantum object outside of the magnetic field gradient zone, and the at least one quantum object is transported back into the magnetic field gradient zone. In an example embodiment, the dynamic decoupling manipulation signal is incident on the at least one quantum object while the at least one quantum object is disposed within the magnetic field gradient zone.

In an example embodiment, the (near field) magnetic field gradient is turned on in the magnetic field gradient zone at least one of (a) while the two or more quantum objects are being transported into the magnetic field gradient zone or (b) while the two or more quantum objects are disposed within the magnetic field gradient zone, and the (near field) magnetic field gradient is turned off in the magnetic field gradient zone at least one of (a) while the two or more quantum objects are being transported out of the magnetic field gradient zone, (b) while the two or more quantum objects are disposed within the magnetic field gradient zone, or (c) after the two or more quantum objects are transported out of the magnetic field gradient zone.

In an example embodiment, the magnetic field gradient is a static magnetic field gradient and is substantially constant over the gate time period.

In an example embodiment, the magnetic field gradient oscillates during the gate time period with a frequency that is less than a motional mode frequency of a motional mode of a respective quantum object of the two or more quantum objects.

According to another aspect, a system configured to perform a geometric phase gate is provided. In an example embodiment, the system comprises a confinement apparatus defining (at least in part) at least one magnetic field gradient zone and operable to confine two or more quantum objects. The system further comprises a controller configured to control operation of the confinement apparatus. The controller is configured to control operation of the confinement apparatus to cause the two or more quantum objects confined by the confinement apparatus to be transported into the at least one magnetic field gradient zone of the confinement apparatus. The two or more quantum objects experience a (near field) magnetic field gradient while disposed in the magnetic field gradient zone. The controller is further configured to, responsive to determining that a gate time period has elapsed with at least one of (a) the two or more quantum objects disposed within the magnetic field gradient zone or (b) the two or more quantum objects experiencing the magnetic field gradient, control operation of the confinement apparatus to cause the two or more quantum objects to stop experiencing the at least one (near field) magnetic field gradient.

In an example embodiment, the confinement apparatus comprises or is associated with at least one of (a) at least one permanent magnet or (b) at least one electromagnet configured to cause the (near field) magnetic field gradient to be present in the at least one magnetic field gradient zone.

In an example embodiment, the confinement apparatus defines a plurality of magnetic field gradient zones, comprising the at least one magnetic field gradient zone, and the two or more quantum objects comprise a plurality of pairs of quantum objects and the controller is configured to cause each of the plurality of pairs of quantum objects to be transported into and out of respective magnetic field gradient zones of the plurality of magnetic field gradient zones substantially simultaneously.

In an example embodiment, the plurality of magnetic field gradient zones form a periodic array of magnetic field gradient zones.

In an example embodiment, the confinement apparatus defines at least one radiating field zone that is spatially distinct from the at least one magnetic field gradient zone and the controller is further configured to, prior to causing transportation of the two or more quantum objects into the at least one magnetic field gradient zone, causing respective quantum states of at least one quantum object of the two or more quantum objects to be evolved to a respective gate subspace state while the at least one quantum object is disposed within the at least one radiating field zone.

In an example embodiment, the two or more quantum objects are entangled within the magnetic field gradient zone during the gate time period without use of any radiating fields to enact/mediate entanglement of the two or more quantum objects.

In an example embodiment, the magnetic field gradient enacts/mediates entanglement of the two or more quantum objects within the magnetic field gradient zone.

In an example embodiment, the gate time period is determined based at least in part on an amount of time it takes for the magnetic field gradient to mediate/enact/cause the entanglement of the two or more quantum objects.

In an example embodiment, the controller is further configured to, prior to transporting the two or more quantum objects into the magnetic field gradient zone, cause respective quantum states of the two or more quantum objects to be evolved to respective gate subspace states.

In an example embodiment, the respective quantum states are evolved out of a memory subspace and into a gate subspace, wherein the respective gate subspace states are respective states of the gate subspace.

In an example embodiment, the memory subspace comprises two or more memory states that are each a respective clock state and the gate subspace comprises two or more gate subspace states that are each Zeeman states.

In an example embodiment, evolving the respective quantum states to the respective gate subspace states comprises causing a manipulation signal characterized by a frequency that is substantially resonant with the frequency difference between at least one memory subspace state and a corresponding gate subspace state to be incident on at least one of the two or more quantum objects.

In an example embodiment, the controller is further configured to, after determining that a gate time period has elapsed, transporting the two or more quantum objects out of the magnetic field gradient zone, and evolving the respective quantum states of the two or more quantum objects from the gate subspace to respective memory states.

In an example embodiment, evolving the respective quantum states of the two or more quantum objects from the gate subspace to respective memory states comprises causing a manipulation signal characterized by a frequency that is substantially resonant with the frequency difference between at least one memory subspace state and a corresponding gate subspace state to be incident on at least one of the two or more quantum objects.

In an example embodiment, the controller is further configured to cause performance of one or more dynamic decoupling sequences on at least one quantum object of the two or more quantum objects between an initiation of the gate time period and a completion of the gate time period.

In an example embodiment, performing the one or more dynamic decoupling sequences on the at least one quantum objects of the two or more quantum objects comprises causing a dynamic decoupling manipulation signal to be incident on the at least one quantum object.

In an example embodiment, the at least one quantum object is transported out of the magnetic field gradient zone, the dynamic decoupling manipulation signal is incident on the at least one quantum object outside of the magnetic field gradient zone, and the at least one quantum object is transported back into the magnetic field gradient zone. In an example embodiment, the dynamic decoupling manipulation signal is incident on the at least one quantum object while the at least one quantum object is disposed within the magnetic field gradient zone.

In an example embodiment, the magnetic field gradient is turned on in the magnetic field gradient zone at least one of (a) while the two or more quantum objects are being transported into the magnetic field gradient zone or (b) while the two or more quantum objects are disposed within the magnetic field gradient zone, and the magnetic field gradient is turned off in the magnetic field gradient zone at least one of (a) while the two or more quantum objects are being transported out of the magnetic field gradient zone, (b) while the two or more quantum objects are disposed within the magnetic field gradient zone, or (c) after the two or more quantum objects are transported out of the magnetic field gradient zone.

In an example embodiment, the magnetic field gradient is a static magnetic field gradient and is substantially constant over the gate time period.

In an example embodiment, the magnetic field gradient oscillates during the gate time period with a frequency that is less than a motional mode frequency of a motional mode of a respective quantum object of the two or more quantum objects.

According to another aspect, a controller configured to control one or more components of a quantum system and configured to cause the quantum system to perform a geometric phase gate is provided. In an example embodiment, the controller comprises a processing device, memory storing executable instructions, and driver controller elements. The executable instructions are configured to, when executed by the processing device, cause the controller to use the driver controller elements to control operation of a confinement apparatus to cause two or more quantum objects confined by the confinement apparatus to be transported into a magnetic field gradient zone of the confinement apparatus. The two or more quantum objects experience a (near field) magnetic field gradient while disposed in the magnetic field gradient zone. The executable instructions are further configured to, when executed by the processing device, cause the controller to use the driver controller elements to, responsive to determining (by the controller) that a gate time period has elapsed with at least one of (a) the two or more quantum objects disposed within the magnetic field gradient zone or (b) the two or more quantum objects experiencing the magnetic field gradient, control operation of the confinement apparatus to cause the two or more quantum objects to stop experiencing the magnetic field gradient.

In an example embodiment, the two or more quantum objects are entangled within the magnetic field gradient zone during the gate time period without use of any radiating fields to enact/mediate entanglement of the two or more quantum objects.

In an example embodiment, the magnetic field gradient enacts/mediates entanglement of the two or more quantum objects within the magnetic field gradient zone.

In an example embodiment, the gate time period is determined based at least in part on an amount of time it takes for the magnetic field gradient to mediate/enact/cause the entanglement of the two or more quantum objects.

In an example embodiment, the executable instructions are further configured to, when executed by the processing device, cause the controller to use the driver controller elements to, prior to transporting the two or more quantum objects into the magnetic field gradient zone, cause respective quantum states of the two or more quantum objects to be evolved to respective gate subspace states.

In an example embodiment, the respective quantum states are evolved out of a memory subspace and into a gate subspace, wherein the respective gate subspace states are respective states of the gate subspace.

In an example embodiment, the memory subspace comprises two or more memory states that are each a respective clock state and the gate subspace comprises two or more gate subspace states that are each Zeeman states.

In an example embodiment, evolving the respective quantum states to the respective gate subspace states comprises causing a manipulation signal characterized by a frequency that is substantially resonant with the frequency difference between at least one memory subspace state and a corresponding gate subspace state to be incident on at least one of the two or more quantum objects.

In an example embodiment, the executable instructions are further configured to, when executed by the processing device, cause the controller to use the driver controller elements to, after determining that a gate time period has elapsed, transporting the two or more quantum objects out of the magnetic field gradient zone, and evolving the respective quantum states of the two or more quantum objects from the gate subspace to respective memory states.

In an example embodiment, evolving the respective quantum states of the two or more quantum objects from the gate subspace to respective memory states comprises causing a manipulation signal characterized by a frequency that is substantially resonant with the frequency difference between at least one memory subspace state and a corresponding gate subspace state to be incident on at least one of the two or more quantum objects.

In an example embodiment, the executable instructions are further configured to, when executed by the processing device, cause the controller to use the driver controller elements to cause performance of one or more dynamic decoupling sequences on at least one quantum object of the two or more quantum objects between an initiation of the gate time period and a completion of the gate time period.

In an example embodiment, performing the one or more dynamic decoupling sequences on the at least one quantum objects of the two or more quantum objects comprises causing a dynamic decoupling manipulation signal to be incident on the at least one quantum object.

In an example embodiment, the at least one quantum object is transported out of the magnetic field gradient zone, the dynamic decoupling manipulation signal is incident on the at least one quantum object outside of the magnetic field gradient zone, and the at least one quantum object is transported back into the magnetic field gradient zone. In an example embodiment, the dynamic decoupling manipulation signal is incident on the at least one quantum object while the at least one quantum object is disposed within the magnetic field gradient zone.

In an example embodiment, the magnetic field gradient is turned on in the magnetic field gradient zone at least one of (a) while the two or more quantum objects are being transported into the magnetic field gradient zone or (b) while the two or more quantum objects are disposed within the magnetic field gradient zone, and the magnetic field gradient is turned off in the magnetic field gradient zone at least one of (a) while the two or more quantum objects are being transported out of the magnetic field gradient zone, (b) while the two or more quantum objects are disposed within the magnetic field gradient zone, or (c) after the two or more quantum objects are transported out of the magnetic field gradient zone.

In an example embodiment, the magnetic field gradient is a static magnetic field gradient and is substantially constant over the gate time period.

In an example embodiment, the magnetic field gradient oscillates during the gate time period with a frequency that is less than a motional mode frequency of a motional mode of a respective quantum object of the two or more quantum objects.

According to another aspect, a method for performing a geometric phase gate is provided. In an example embodiment, the method comprises causing, by a controller of a quantum system, two or more qubits of the quantum system to experience a (near field) magnetic field gradient; and responsive to determining that a gate time period has elapsed since the two or more qubits of the quantum system started to experience the magnetic field gradient, causing, by the controller, the two or more qubits to no longer experience the magnetic field gradient.

In an example embodiment, the gate time period is determined based at least in part on an amount of time it takes for the magnetic field gradient to mediate/enact/cause the entanglement of the two or more qubits.

In an example embodiment, the two or more qubits are entangled within the magnetic field gradient zone during the gate time period without use of any radiating fields to enact/mediate entanglement of the two or more qubits.

In an example embodiment, the (near field) magnetic field gradient enacts/mediates entanglement of the two or more qubits within the magnetic field gradient zone.

In an example embodiment, the magnetic field gradient is a static magnetic field gradient and is substantially constant over the gate time period.

In an example embodiment, the magnetic field gradient oscillates during the gate time period with a frequency that is less than a motional mode frequency of a motional mode of a respective quantum object of the two or more quantum objects.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a block diagram of an example quantum charge-coupled device (QCCD)-based quantum system, in accordance with an example embodiment.

FIG. 2 provides a schematic diagram of a top view of an example confinement region of a confinement apparatus that includes a magnetic field gradient zone, in accordance with an example embodiment.

FIG. 3 provides a schematic diagram of a top view of at least a portion of a confinement apparatus, in accordance with an example embodiment.

FIG. 4 provides flowchart illustrating processes, procedures, and/or operations for performing a geometric phase gate, in accordance with an example embodiment.

FIG. 5 provides a flowchart illustrating processes, procedures, and/or operations for performing a geometric phase gate, in accordance with various embodiments.

FIG. 6 provides an example partial quantum state diagram illustrating a memory subspace and a gate subspace, in accordance with an example embodiment.

FIG. 7 provides a schematic diagram of an example controller of a quantum system, in accordance with an example embodiment.

FIG. 8 provides a schematic diagram of an example computing entity of a quantum system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “I”) is used herein in both the alternative and conjunctive sense, unless otherwise indicated. The terms “illustrative” and “exemplary” are used to be examples with no indication of quality level. The terms “generally” and “approximately” refer to within appropriate engineering and/or manufacturing limits and/or within user measurement capabilities, unless otherwise indicated. Like numbers refer to like elements throughout.

Various embodiments, provide methods, quantum systems, controllers, computer program products, and/or the like for performing a quantum logic gate. As used herein, a quantum logic gate is performed on two or more quantum objects by gating the two or more quantum objects with one another and/or causing an interaction between/among the two or more quantum objects such that the logic function of the quantum logic gate is enacted through the interaction of the two or more quantum objects. In various embodiment, the quantum logic gate is a geometric phase gate that includes the entanglement of two or more qubits. The entanglement of the two or more qubits is enacted, mediated, and/or caused to occur by a (near field) magnetic field gradient. In particular, the entanglement of the two or more qubits does not require any radiating fields (e.g., laser beams, microwaves and/or the like). For example, no radiating fields are used to enact, mediate, and/or cause the entanglement of the two or more qubits, in various embodiments of the quantum logic gate. Rather, a magnetic field gradient is used to eliminate spin-motion entanglement of the quantum objects embodying the qubits and to enact, mediate, and/or cause entanglement between the respective quantum states of the quantum objects.

Moreover, from the perspective of the quantum objects, the magnetic field gradient is turned on and off slowly such that the spin-motion entanglement of the quantum objects is adiabatically eliminated for performance of the quantum logic gate. As used herein, the term “slowly” relates to the magnetic field gradient being turned on (for performance of the quantum logic gate) and/or turned off (after performance of the quantum logic gate) at a time scale that is slow compared to the motional frequency of the qubits, which is dictated by the trap confinement (e.g., operation of the confinement apparatus).

As used herein the near field magnetic field gradient is the gradient of the near field portion of the magnetic field generated by respective magnetic field gradient source. For example, the near field portion of the magnetic field is a portion of the magnetic field where the amplitude of the magnetic field at a distance r from the magnetic field gradient source is proportional to 1/r². For example, the near field portion of the magnetic field is a portion of the magnetic field within a distance of c/f of the magnetic field gradient source, where f is the frequency of any oscillations of the magnetic field and c is the speed of light. In an example embodiment, the near field portion of the magnetic field is a portion of the magnetic field within a distance of c/(2πf) of the magnetic field gradient source. For example, the near field magnetic field gradient is the gradient of a non-radiating magnetic field.

In various embodiments, performing the quantum logic gate comprises causing two or more qubits to experience a magnetic field gradient. After and/or responsive to determining that a gate time period has elapsed since the two or more qubits started experiencing the (near field) magnetic field gradient, the two or more qubits are caused to no longer experience the (near field) magnetic field gradient.

For example, in an example embodiment, performing the quantum logic gate comprises controlling the operation of a confinement apparatus confining two or more quantum objects to cause the two or more quantum objects to be transported into a magnetic field gradient zone that is defined by a confinement apparatus and a magnetic field gradient source (e.g., a permanent magnet, permanent magnet array, electromagnet, electromagnet array, a combined array of permanent and electromagnets, and/or the like). While the two or more qubits are disposed within the magnetic field gradient zone, they experience a magnetic field gradient. After and/or responsive to the two or more qubits being disposed in the magnetic field gradient zone for a gate time period, the two or more qubits are transported out of the magnetic field gradient zone. In an example embodiment, the gate time period is determined at least in part based on an amount of time it takes for the magnetic field gradient to enact, mediate, and/or cause an entanglement of the quantum states of the two or more quantum objects.

Performance of conventional quantum logic gates require radiating fields such as laser beams, microwaves, and/or the like to enact, mediate, and/or cause the entanglement of qubits. However, these radiating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use radiating fields are highly sensitive to the state of one or more motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

Various embodiments provide technical solutions to these technical problems. In various embodiments, a quantum logic gate is performed by using a (near field) magnetic field gradient to enact, mediate, and/or cause entanglement of two or more qubits. Since the (near field) magnetic field gradient is the gradient of at least a portion of a magnetic field that is a non-radiating field, the quantum logic gate disclosed herein is immune to phase noise and the primary mechanisms leading to cross talk-related errors. Additionally, the quantum logic gate of various embodiments is insensitive to the motional mode and/or temperature of the qubits. Thus, time intensive cooling operations can be avoided and/or reduced. As such, various embodiments provide an improved quantum logic gate, methods for performing an improved quantum logic gate, quantum systems configured for performing an improved quantum logic gate, controller configured to cause quantum systems to perform an improved quantum logic gate, and/or the like.

Various embodiments of an example quantum logic gate will now be described with respect to an example QCCD-based quantum system.

### Example QCCD-Based Quantum System

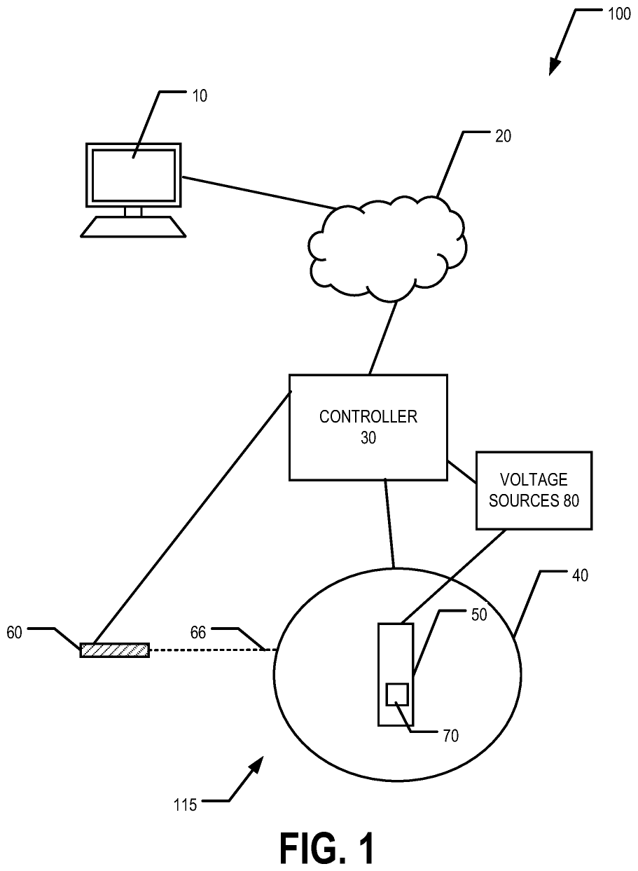

FIG. 1 provides a schematic diagram of an example QCCD-based quantum system 100 that can be used to perform a quantum logic gate of various embodiments. The example QCCD-based quantum system 100 shown in FIG. 1 is a quantum computer system comprising a quantum object confinement apparatus 50 (e.g., an ion trap) defining, at least in part, at least one magnetic field gradient zone. For example, the confinement apparatus 50 comprises or is physically associated a magnetic field gradient source 70.

In various embodiments, the magnetic field gradient source 70 is a permanent magnet (e.g., a ferromagnet) and/or an array of permanent magnets that is part of the confinement apparatus 50 (e.g., disposed and/or embedded in the same substrate and/or chip as the confinement apparatus 50) or disposed in physical proximity to the confinement apparatus 50 such that quantum objects confined within a magnetic field gradient zone of the confinement apparatus experience a magnetic field gradient. In an example embodiment, the magnetic field gradient source 70 is an electromagnet, an array of electromagnets, and/or an array of magnets comprising at least one electromagnet and at least one permanent magnet that is part of the confinement apparatus 50 (e.g., disposed and/or embedded in the same substrate and/or chip as the confinement apparatus 50) or disposed in physical proximity to the confinement apparatus 50 such that quantum objects confined within a magnetic field gradient zone of the confinement apparatus experience a magnetic field gradient.

In various embodiments, the magnetic field gradient source 70 is configured to generate a static magnetic field gradient where there magnetic field gradient is substantially constant and/or non-changing over time (e.g., over the gate time period). In various embodiments, the magnetic field gradient source 70 is configured to generate an oscillating magnetic field gradient where the magnetic field gradient oscillates over time with a frequency that is slow compared to and/or less than a motional frequency of a motional mode of the quantum objects embodying the qubits. For example, in an example embodiment, the magnetic field gradient oscillates with a frequency that is approximately 100 kHz or more detuned from the motional frequency of one or more motional modes of the quantum objects embodying the qubits. For example, the magnetic field gradient may oscillate such that the spin-motion coupling of the quantum objects is reduced and/or eliminated via interaction of the quantum object with the magnetic field gradient during the performance of the quantum logic gate.

In various embodiments, the confinement apparatus 50 is configured to confine quantum objects in one or more confinement regions defined by the confinement apparatus 50. In various embodiments, a quantum object is a neutral or charged atom; a neutral, charged, or multipole molecule; quantum particle; quantum dot; or other object that is able to be confined by the confinement apparatus and having a quantum state that is manipulatable via one or more manipulation signals and/or interactions with electric and/or magnetic fields. In various embodiments, the quantum objects embody the qubits of the QCCD-based quantum system 100. In an example embodiment, the confinement apparatus 50 is an ion trap and the quantum objects are ions.

In various embodiments, the QCCD-based quantum system 100 comprises a computing entity 10 and a quantum computer 110. In various embodiments, the quantum computer 110 comprises a controller 30 and a quantum processor 115. In various embodiments, the quantum processor 115 comprises a cryogenic and/or vacuum chamber 40 enclosing a confinement apparatus 50 and magnetic field gradient source 70, and one or more manipulation sources 60. In an example embodiment, the one or more manipulation sources 60 comprise one or more optical sources such as lasers, microwave sources, and/or the like.

In various embodiments, the one or more manipulation sources 60 are configured to generate and/or provide manipulation signals (e.g., optical beams) configured to manipulate and/or cause a controlled quantum state evolution of one or more quantum objects confined by the confinement apparatus 50. For example, in an example embodiment, wherein the one or more manipulation sources 60 comprise one or more lasers, the lasers may provide one or more optical beams and/or laser beams (e.g., pi pulses, for example) to the confinement apparatus 50 within the cryogenic and/or vacuum chamber 40 via respective beam delivery systems 66. In various embodiments, a beam delivery system 66 comprises one or more optical elements, photonic integrated circuits (PICs), optical fibers, free space optical elements, waveguides, and/or the like.

In various embodiments, the quantum processor 115 further comprises a plurality of voltage sources 80. The voltage sources 80 are operable (e.g., by the controller 30) to generate and provide voltage signals to electrical elements (e.g., electrodes) of the confinement apparatus 50, any electromagnets of the magnetic field gradient source 70, and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control the voltage sources 80, cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects (e.g., ions) confined by the confinement apparatus 50 (e.g., ion trap). In various embodiments, the quantum objects confined by the confinement apparatus 50 are used as qubits of the quantum computer 110.

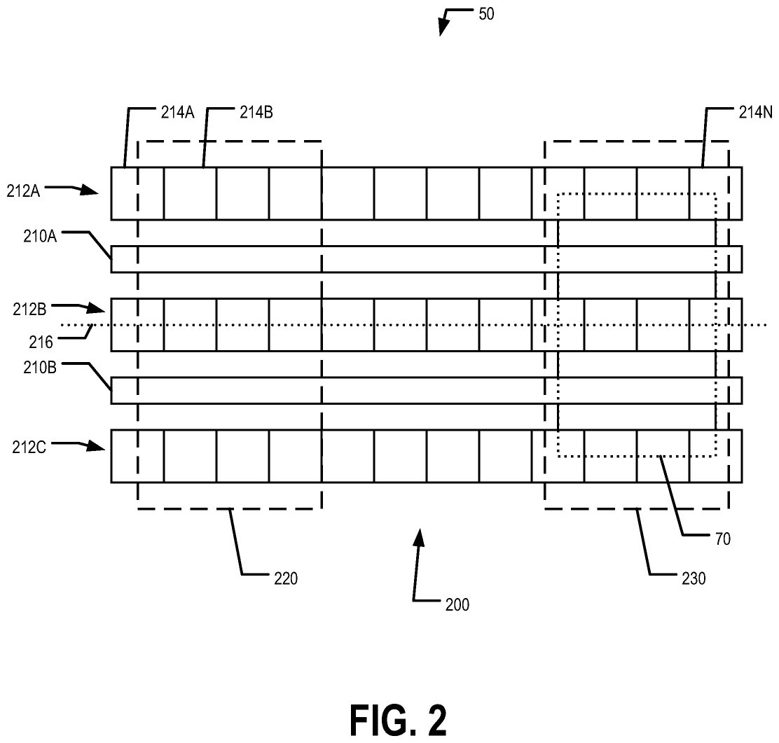

FIG. 2 illustrates a top view of a portion of a confinement apparatus 50. The illustrated portion of the confinement apparatus 50 includes radio frequency (RF) rails 210A, 210B and three sequences of control electrodes 212A, 212B, 212C. Each sequence of control electrodes 212 comprises a plurality of control electrodes 214. For example, the illustrated portion of the sequence of control electrodes 212A includes control electrodes 214A, 214B, . . . , 214N.

In various embodiments, RF voltage sources of the voltage sources 80 generate and provide an RF voltage signal that is applied to the RF rails 210A, 210B to generate a pseudopotential that defines one or more linear confinement regions 200 of the confinement apparatus 50. The null point of the pseudopotential generated by the RF voltage signals being applied to the RF rails 210A, 210B defines the RF null axis 216 that extends substantially along a center line of the linear confinement region 200. The quantum objects confined by the confinement apparatus 50 are confined in the one or more linear confinement regions 200.

In various embodiments, the confinement apparatus 50 and the magnetic field gradient source 70 define a magnetic field gradient zone 230. When a quantum object is confined by the confinement apparatus 50 within the magnetic field gradient zone 230, the quantum object experiences a (near field) magnetic field gradient. For example, the magnetic field gradient zone 230 is disposed within and/or corresponds to the near field region of the magnetic field generated by the magnetic field gradient source 70.

In various embodiments, the confinement apparatus 50 and one or more beam delivery systems 66 define a radiating field zone 220. In various embodiments, the radiating field zone 220 is configured such that when a quantum object is disposed within the radiating field zone 220, a manipulation signal may be incident on the quantum object. For example, the beam delivery system 66 is configured such that a manipulation signal generated by a manipulation source 60 is applied to the confinement apparatus 50 within the radiating field zone 220 such that the manipulation signal may be incident on a quantum object disposed within the radiating field zone 220.

The quantum objects confined by the confinement apparatus 50 may be transported between different locations of the confinement apparatus 120 through the application of sets of voltage signal sequences to the control electrodes 212. For example, the a quantum object (or multiple quantum objects) may be transported back and forth between the radiating field zone 220 and the magnetic field gradient zone 230 and/or other locations defined by the confinement apparatus 50. For example, the controller 30 is configured to control the voltage sources 80 to cause performance of a transport operation on a quantum object (or group of quantum objects) between various locations defined by the confinement apparatus 50.

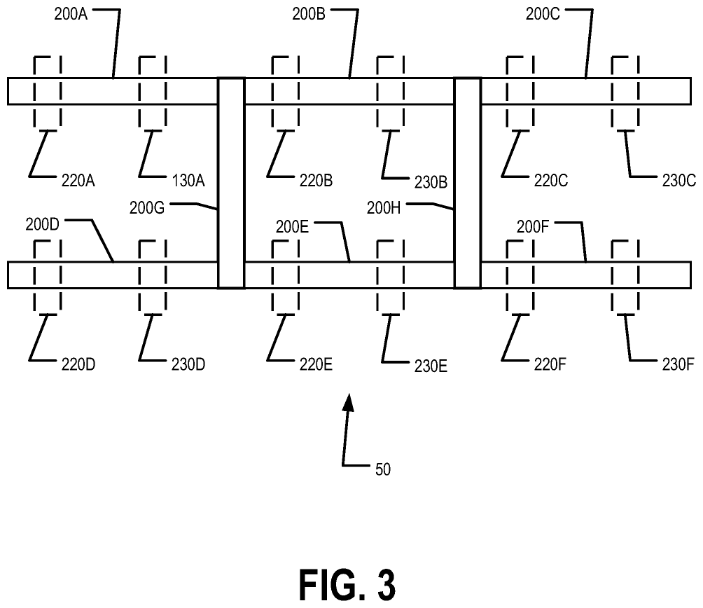

In an example embodiment, the confinement apparatus 50 comprises and/or defines a single linear confinement region 200. In various embodiments, the confinement apparatus 50 comprises and/or defines a plurality and/or an array of confinement regions 200. FIG. 3 provides a top view of a portion of a confinement apparatus 50 illustrating a two-dimensional array of confinement regions 200 (e.g., 200A, 200B, 200C, 200D, 200E, 200F, 200G, 200H). In the illustrated embodiment, a plurality of radiating field zones 220 (e.g., 220A, 220B, 220C, 220D, 220E, 220F) and/or a plurality of magnetic field gradient zones 230 (e.g., 230A, 230B, 230C, 230D, 230E, 230F) are defined along the array of confinement regions. For example, the plurality of a plurality of radiating field zones 220 (e.g., 220A, 220B, 220C, 220D, 220E, 220F) and/or a plurality of magnetic field gradient zones 230 (e.g., 230A, 230B, 230C, 230D, 230E, 230F) provide a periodic array of radiating field zones 220 and/or magnetic field gradient zones, respectively, in the illustrated embodiment.

### Example Operation of a Quantum System to Perform a Quantum Logic Gate

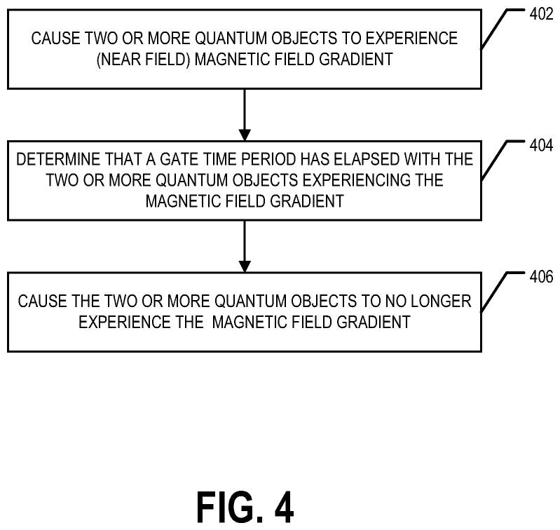

In various systems, a quantum system, such as the QCCD-based quantum system 100 is operable to perform a quantum logic gate such that a (near field) magnetic field gradient is used to enact, mediate, and/or cause the entanglement of two or more qubits corresponding to quantum logic gate. FIG. 4 provides a flowchart illustrating various processes, procedures, operations, and/or the like that may be performed (e.g., by a controller 30) to cause a quantum logic gate to be performed in accordance with various embodiments.

In various embodiments, the quantum logic gate performed through the processes, procedures, operations, and/or the like of FIG. 4 causes the entanglement of two or more qubits with the entanglement enacted, mediated, and/or caused by a (near field) magnetic field gradient. In various embodiments, no radiating fields are used to enact, mediate, and/or cause the entanglement of the two or more qubits when the quantum logic gate is performed.

In various embodiments, qubits (e.g., quantum bits) are embodied as quantum objects. For example, the quantum state of a quantum object is used to encode information that is the result of a quantum computation. For example, the controlled evolution of the respective quantum states of a plurality of quantum objects results in the performance of a quantum computation. The terms quantum object and qubit are used interchangeably herein.

Responsive to determining that two or more quantum objects are to be interacted with one another via a quantum logic gate, the controller 30 make transport the two or more quantum objects to a common location. In an example embodiment, the common location is within a magnetic field gradient zone 230. In an example embodiment, the common location is outside of a magnetic field gradient zone 230.

At step/operation 402, the controller 30 causes the two or more quantum objects to be interacted with one another via the quantum logic gate to begin experiencing the (near field) magnetic field gradient. In an example embodiment, the two or more quantum objects begin experiencing the (near field) magnetic field gradient as a result of being transported into the magnetic field gradient zone 230. For example, the controller 30 controls the operation of the voltage sources 80 and/or confinement apparatus 50 to cause the two or more quantum objects to be transported into the magnetic field gradient zone 230 such that the two or more quantum objects begin to experience the (near field) magnetic field gradient. In an example embodiment, the magnetic field gradient source 70 comprises one or more electromagnets and the two or more quantum objects begin to experience the (near field) magnetic field gradient because the electromagnet is operated to cause the (near field) magnetic field gradient to be present in the magnetic field gradient zone 230.

In various embodiments, the two or more quantum objects experience the magnetic field gradient being turned on (due to the quantum objects being moved into the field gradient zone 230 or a magnetic field generating circuit being turned on) slowly. In particular, the quantum objects experience the magnetic field gradient being turned on and/or ramped up at a time scale that is slow compared to the motional frequency of the qubits, which is dictated by the trap confinement (e.g., operation of the confinement apparatus).

At step/operation 404, the controller 30 determines that a gate time period has elapsed with the two or more quantum objects experiencing the (near field) magnetic field gradient. For example, the controller 30 may determine that a gate time period has elapsed since the two or more quantum objects were transported into the (near field) magnetic field gradient zone 230.

In various embodiments, the gate time period is determined based at least in part on an amount of time that it takes for the (near field) magnetic field gradient to enact, mediate, and/or cause the entanglement of two or more quantum objects. In an example embodiment, the (near field) magnetic field gradient has a magnetic field strength and/or amplitude of greater than 100 T/m and the gate time period is less than 10⁴ μs. In an example embodiment, the (near field) magnetic field gradient has a magnetic field strength and/or amplitude of greater than 200 T/m and the gate time period is less than 3×10³ μs. In an example embodiment, the (near field) magnetic field gradient has a magnetic field strength and/or amplitude of greater than 300 T/m and the gate time period is less than 10³ μs. For example, in various embodiments, the gate time period is determined at least in part based on a function of the magnetic field strength and/or amplitude of the magnetic field gradient, a motional frequency of one or more motional modes of the quantum objects, and/or the like.

In an example embodiment, the magnetic field gradient is a static magnetic field gradient and is generally constant during the gate time period. In an example embodiment, the magnetic field gradient is an oscillating magnetic field gradient that oscillates with a frequency that is less than the motional frequency of the one or more motional modes of the quantum objects. For example, the magnetic field gradient may oscillate such that the spin-motion coupling of the quantum objects is reduced and/or eliminated via interaction of the quantum object with the magnetic field gradient during the performance of the quantum logic gate.

At step/operation 406, after and/or responsive to determining that the gate time period has elapsed with the two or more quantum objects experiencing the (near field) magnetic field gradient, the controller 30 causes the two or more quantum objects to stop experiencing the (near field) magnetic field gradient. For example, after and/or responsive to determining that the two or more quantum objects have been disposed in the magnetic field gradient zones 230 for the gate time period, the controller 30 may control operation of the voltage sources 80 and/or confinement apparatus 50 to cause the two or more quantum objects to be transported out of the magnetic field gradient zone 230. As a result of being transported out of the magnetic field gradient zone 230, the two or more quantum objects stop experiencing the magnetic field gradient. In an example embodiment, wherein the magnetic field gradient source 70 comprises at least one electromagnet, the controller 30 may turn off the at least one electromagnet to cause the two or more quantum objects to stop experiencing the (near field) magnetic field gradient.

In various embodiments, the two or more quantum objects experience the magnetic field gradient being turned off (due to the quantum objects being moved out of the field gradient zone 230 or a magnetic field generating circuit being turned off) slowly. In particular, the quantum objects experience the magnetic field gradient being turned off and/or ramped down at a time scale that is slow compared to the motional frequency of the qubits, which is dictated by the trap confinement (e.g., operation of the confinement apparatus).

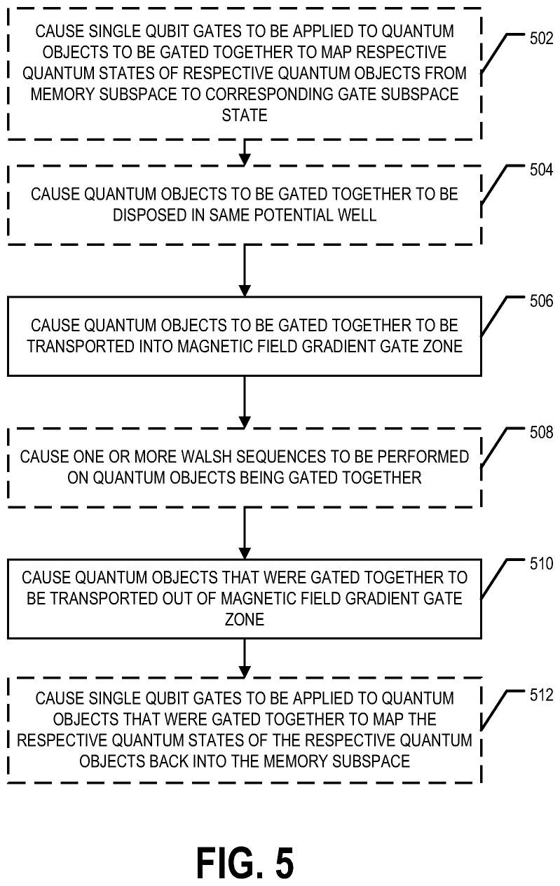

FIG. 5 provides a flowchart illustrating various processes, procedures, operations, and/or the like that may be performed (e.g., by a controller 30) to cause a quantum logic gate to be performed in accordance with various embodiments. In various embodiments, the quantum logic gate performed through the processes, procedures, operations, and/or the like of FIG. 5 causes the entanglement of the quantum states of two or more quantum objects with the entanglement enacted, mediated, and/or caused by a (near field) magnetic field gradient. In various embodiments, no radiating fields are used to enact, mediate, and/or cause the entanglement of the quantum states of the two or more quantum objects when the quantum logic gate is performed.

In various embodiments, the controller 30 determines (e.g., based on a quantum circuit and/or algorithm being executed by the quantum processor 115) that a quantum logic gate is to be performed on two or more quantum objects confined by the confinement apparatus 50. The controller 30 may, responsive thereto, initiate the performance of the quantum logic gate at step/operation 502.

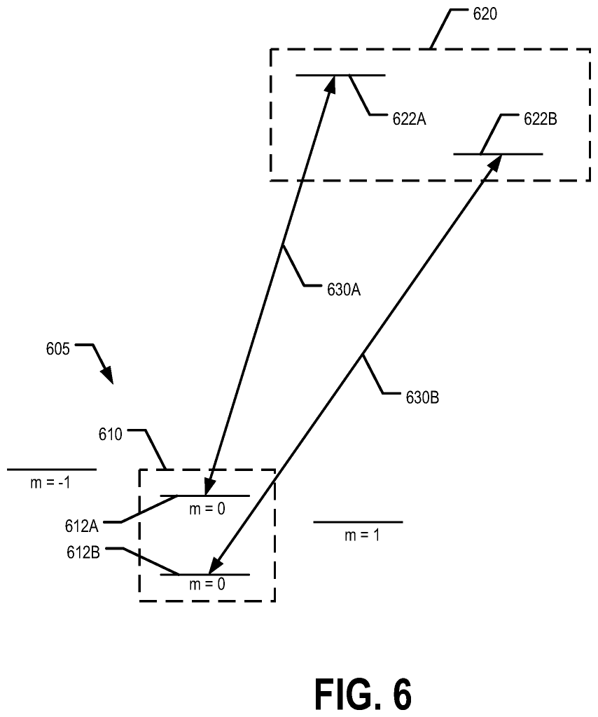

At step/operation 502, the respective quantum states of the two or more quantum objects are mapped, evolved, and/or transformed to respective and/or corresponding gate subspace states in a gate subspace. For example, a memory subspace is defined as a subset of the quantum states of the quantum objects. FIG. 6 illustrates a partial energy diagram illustrating some of the quantum states of a quantum object. A memory subspace 610 is defined in a ground state manifold 605 (e.g., S-manifold) of the quantum object. In the illustrated embodiment, the memory subspace 610 comprises two quantum states—a first memory state 612A and a second memory state 612B. In the illustrated embodiment, the first and second memory states 612A, 612B are clock states (e.g., magnetic quantum number m=0).

In various embodiments, a gate subspace 620 is defined. In particular, the gate subspace 620 is defined to include a first gate subspace state 622A and a second gate subspace state 622B. The first gate subspace state 622A is chosen and/or selected such that the first memory state 612A may be coupled to the first gate subspace state 622A via a first manipulation signal 630A. For example, the first manipulation signal 630A is a pi pulse of a laser beam characterized by a frequency that is resonant or close to resonant with the energy difference between the first memory state 612A and the first gate subspace state 622A, in an example embodiment.

The second gate subspace state 622B is chosen and/or selected such that the second memory state 612B may be coupled to the second gate subspace state 622B via a second manipulation signal 630B. For example, the second manipulation signal 630B is a pi pulse of a laser beam characterized by a frequency that is resonant or close to resonant with the energy difference between the second memory state 612B and the second gate subspace state 622B. In an example embodiment, the first and second manipulation signals are characterized by the same frequency (e.g., the frequency difference between the first memory state 612A and the first gate subspace state 622A and the frequency difference between the second memory state 612B and the second gate subspace state 622B may be substantially equal). In an example embodiment, the first and second manipulation signals are characterized by different frequencies.

In an example embodiment where the first and second memory states 612A, 612B are clock states, the memory states are relatively insensitive to magnetic fields. However, the gate subspace states 622A, 622B are chosen or selected to be Zeeman states with quantum number m≠0 such that the gate subspace states are sensitive to magnetic fields.

Returning to FIG. 5, at step/operation 502, the controller 30 causes single qubit gates to be applied to each of the two or more quantum objects on which the quantum logic gate is to be performed to map and/or transform the respective quantum states of each of the two or more quantum objects to respective corresponding gate subspace states 622. For example, the controller 30 may cause each of the two or more quantum objects on which the quantum logic gate is to be performed to be transported to a radiating field zone 220. In various embodiments, the two or more quantum objects may be transported to the same radiating field zone 220 or different radiating field zones. In various embodiments, the two or more quantum objects may be transported into the radiating field zone(s) 220 serially or in parallel. The controller 30 then controls operation of one or more manipulation sources 60 and/or beam delivery systems 66 to cause first and/or second manipulation signals 630A, 630B to be incident on at least a portion of the radiating field zone 220 (and therefore incident on at least one of the two or more quantum objects). As a result of the first and/or second manipulation signal being incident on the at least one of the two or more quantum objects, the quantum state of the quantum object is mapped and/or transformed from the respective memory state 612 (or superposition of memory states 612) to the respective gate subspace state 622 (or superposition of gate subspace states 622).

At step/operation 504, if the two or more quantum objects upon which the quantum logic gate is to be performed are not disposed within a same potential well of the confinement apparatus 50, the controller 30 causes a transportation operation to be performed such that the two or more quantum objects upon which the quantum logic gate is to be performed are disposed within a same potential well of the confinement apparatus 50.

At step/operation 506, the controller 30 causes the two or more quantum objects upon which the quantum logic gate is to be performed to be transported into the magnetic field gradient zone 230. For example, the controller 30 may control operation of the voltage sources 80 and/or confinement apparatus 50 such that the potential well in which the two or more quantum objects are disposed to be transported into the magnetic field gradient zone 230. Thus, the two or more quantum objects start and/or begin to experience the (near field) magnetic field gradient while they are disposed within the magnetic field gradient zone 230.

In an example embodiment, the (near field) magnetic field gradient is present in the magnetic field gradient zone 230 prior to the two or more quantum objects being transported into the magnetic field gradient zone 230. In various embodiments, the magnetic field gradient source 70 comprises one or more electromagnets and the magnetic field gradient zone is turned on and/or caused to be present on (e.g., the current flow to the electromagnet(s) is increased to a steady state current flow having an absolute value of greater than zero) as the two or more quantum objects are being transported into the magnetic field gradient zone 230 and/or once the two or more quantum objects are disposed within the magnetic field gradient zone 230.

At step/operation 508, the controller 30 causes one or more dynamic decoupling sequences to be performed on at least one of the two or more quantum objects upon which the quantum logic gate is being performed. In various embodiments, the one or more dynamic decoupling sequences are performed to prevent and/or mitigate the effects of spin-decoherence of at least one of the two or more quantum objects. In various embodiments, a dynamic decoupling sequence comprises applying a pi pulse to at least one of the two or more qubits, causing the spin of the qubit to flip. In an example embodiment, the one or more dynamic decoupling sequences comprise one or more Walsh sequences. Various other dynamic decoupling sequences are used in various other embodiments.

In various embodiments, one or more dynamic decoupling sequences are performed respectively on one or more of the two or more quantum objects during the gate time period. For example, for a gate time period t_{g}, one or more dynamic decoupling sequences may be performed on respective quantum objects at times 0<t≤t_{g}, where the time t=0 is when the transportation of the two or more quantum objects into the magnetic field gradient zone 230 is completed, in an example embodiment. In various embodiments, the timing of the performance of the dynamic decoupling sequence(s) is determined based in part on the dynamic decoupling sequence(s) utilized.

In various embodiments, the controller 30 is configured to perform a dynamic decoupling sequence on a quantum object by controlling operation of one or more manipulation sources 60 to cause on or more dynamic decoupling manipulation signals to be incident on a respective quantum object of the two or more quantum objects. In an example embodiment, a dynamic decoupling manipulation signal is a pi-pulse configured to correct and/or prevent errors caused by the energy splitting of the qubit drifting in an uncontrolled manner during performance of the quantum logic gate.

In various embodiments, the one or more dynamic decoupling manipulation signals are incident on the respective quantum objects while the quantum objects are disposed within the magnetic field gradient zone 230. For example, in an example embodiment, when it is time to perform a dynamic decoupling sequence, the (near field) magnetic field gradient is turned off (e.g., when the magnetic field gradient source 70 comprises one or more electromagnets, the current flow to the electromagnets is reduced to nominally zero), the dynamic decoupling manipulation signals are applied to the respective quantum objects, and then the (near field) magnetic field gradient is turned back on (e.g., the current flow to the electromagnets is increased to a steady state current flow having an absolute value of greater than zero). In an example embodiment, when it is time for a dynamic decoupling sequence to be performed on a quantum object, the quantum object is transported out of the magnetic field gradient zone 230 (e.g., possibly into a radiating field zone 220), the dynamic decoupling manipulation signal is incident on the quantum object, and then the quantum object is transported back into the magnetic field gradient zone 230.

In various embodiments, the clock used to determine that the gate time period has elapsed since the two or more quantum objects started to experience the (near field) magnetic field gradient and/or since the (initial) transportation of the two or more quantum objects into the magnetic field gradient zone 230 was completed, is paused during the performance of the one or more dynamic decoupling sequences. In an example embodiment, the gate time period is determined and/or defined to include time for the one or more dynamic decoupling sequences to be performed during the gate time period and the clock is not paused for performance of the one or more dynamic decoupling sequences.

At step/operation 510, after and/or responsive to determining that a gate time period has elapsed since the two or more quantum objects started to experience the (near field) magnetic field gradient and/or since the (initial) transportation of the two or more quantum objects into the magnetic field gradient zone 230 was completed, the controller 30 controls operation of the voltage sources 80 and/or confinement apparatus 50 to cause the two or more quantum objects to be transported out of the magnetic field gradient zone 230. For example, after and/or responsive to determining that the two or more quantum objects have been disposed in the magnetic field gradient zones 230 for the gate time period, the controller 30 may control operation of the voltage sources 80 and/or confinement apparatus 50 to cause the two or more quantum objects to be transported out of the magnetic field gradient zone 230. As a result of being transported out of the magnetic field gradient zone 230, the two or more quantum objects stop experiencing the (near field) magnetic field gradient, in an example embodiment. For example, in various embodiments in which the magnetic field gradient source 70 comprises one or more electromagnets, the (near field) magnetic field gradient is turned off (e.g., the current flow to the electromagnets is reduced to nominally zero) prior to, during, or after the two or more quantum objects are transported out of the magnetic field gradient zone 230.

In various embodiments, the gate time period is determined based at least in part on an amount of time that it takes for the (near field) magnetic field gradient to enact, mediate, and/or cause the entanglement of two or more quantum objects. In an example embodiment, the (near field) magnetic field gradient has a magnetic field strength and/or amplitude of greater than 100 T/m and the gate time period is less than 10⁴ μs. In an example embodiment, the (near field) magnetic field gradient has a magnetic field strength and/or amplitude of greater than 200 T/m and the gate time period is less than 3×10³ μs. In an example embodiment, the (near field) magnetic field gradient has a magnetic field strength and/or amplitude of greater than 300 T/m and the gate time period is less than 10³ μs. For example, in various embodiments, the gate time period is determined at least in part based on a function of the magnetic field strength and/or amplitude of the (near field) magnetic field gradient, a motional frequency of one or more motional modes of the quantum objects, and/or the like. In an example embodiment, the gate time period is determined based at least in part on the amount of time needed to perform the one or more dynamic decoupling sequences performed as part of step/operation 508.

At step/operation 512, the controller 30 causes single qubit gates to be applied to each of the two or more quantum objects on which the quantum logic gate was performed to map and/or transform the respective quantum states of each of the two or more quantum objects from the respective gate subspace states 622 back to corresponding states in the memory subspace 610. For example, the respective quantum states of the two or more quantum objects are mapped, evolved, and/or transformed to respective and/or corresponding memory states 612 in the memory subspace 610. For example, the controller 30 may cause each of the two or more quantum objects on which the quantum logic gate was performed to be transported to a radiating field zone 220. In various embodiments, the two or more quantum objects may be transported to the same radiating field zone 220 or different radiating field zones. In various embodiments, the two or more quantum objects may be transported into the radiating field zone(s) 220 serially or in parallel. The controller 30 then controls operation of one or more manipulation sources 60 and/or beam delivery systems 66 to cause first and/or second manipulation signals 630A, 630B to be incident on at least a portion of the radiating field zone 220 (and therefore on at least one of the two or more quantum objects). As a result of the first and/or second manipulation signals being incident on the at least one of the two or more quantum objects, the quantum state of the quantum object is mapped and/or transformed from the respective gate subspace state 622 (or superposition of gate subspace states 622) to the respective memory state 612 (or superposition of memory states 612).

After the performance of the quantum logic gate is completed, the controller 30 may continue to control operation of various components of the quantum processor 115 to cause the quantum processor 115 to continue and/or finish performing the quantum circuit and/or algorithm including the quantum logic gate. For example, respective quantum objects of the two or more quantum objects may be transported, have one or more single qubit gates performed thereon, have one or more two or more qubit gates performed thereon, have one or more read operations performed thereon, and/or the like, in accordance with the quantum circuit and/or algorithm.

As should be understood, the first and second manipulation signals used to map the respective quantum states of the two or more quantum objects from memory subspaces states to gate subspace states or vice versa and the dynamic decoupling manipulation signals used to perform the one or more dynamic decoupling sequences are each acting independently on a single quantum object. In other words, the first and second manipulation signals and the dynamic decoupling manipulation signals do not enact, mediate, and/or cause interaction and/or entanglement between two or more quantum objects. The interaction and/or entanglement between the two or more quantum objects in enacted, mediated, and/or caused solely by the (near field) magnetic field gradient.

### Technical Advantages

Performance of conventional quantum logic gates require radiating fields such as laser beams, microwaves, and/or the like to enact, mediate, and/or cause the entanglement of qubits. However, these radiating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use radiating fields are highly sensitive to state of one or more the motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

Various embodiments provide technical solutions to these technical problems. In various embodiments, a quantum logic gate is performed by using a (near field) magnetic field gradient (e.g., the gradient of a non-radiating magnetic field) to enact, mediate, and/or cause entanglement of two or more qubits. Since the (near field) magnetic field gradient oscillates with a frequency that is less than a motional frequency of one or more motional frequencies of the quantum objects embodying qubits (or is static), the quantum logic gate disclosed herein is immune to phase noise and the primary mechanisms leading to cross talk-related errors. As an optical beam is not used to enact, mediate, or cause the entanglement of the two or more quantum objects, photon scattering error sources are reduced. Additionally, the quantum logic gate of various embodiments is insensitive to the motional mode and/or temperature of the qubits. Thus, time intensive cooling operations can be avoided and/or reduced. As such, various embodiments provide an improved quantum logic gate, methods for performing an improved quantum logic gate, quantum systems configured for performing an improved quantum logic gate, controller configured to cause quantum systems to perform an improved quantum logic gate, and/or the like.

### Example Controller

In various embodiments, a confinement apparatus 50 and an associated at least one magnetic field gradient source 70 that define at least one magnetic field gradient zone 230 are part of a QCCD-based quantum system 100. In various embodiments, the QCCD-based quantum system 100 comprises a controller 30 configured, for example. To control operation of various components of a quantum processor 115. For example, the controller 30 is configured to control the voltage sources 80 configured to provide electrical control signals to the sequences of control electrodes 212 of the confinement apparatus 50. The controller 30 may be further configured to control a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the quantum object confinement apparatus 50.

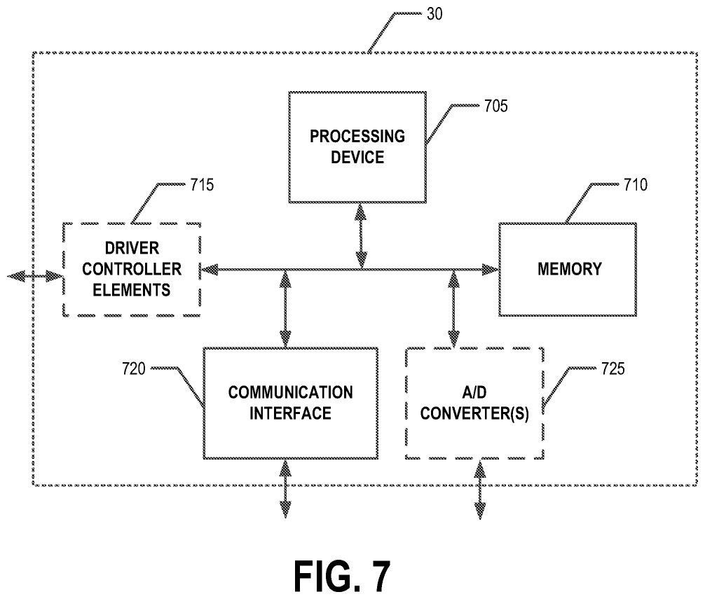

As shown in FIG. 7, in various embodiments, the controller 30 may comprise various controller elements including processing elements 705, memory 710, driver controller elements 715, a communication interface 720, analog-digital converter elements 725, and/or the like. For example, the processing elements 705 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. And/or controllers. The term circuitry may refer to an entirely hardware embodiment or a combination of hardware and computer program products. In an example embodiment, the processing element 705 of the controller 30 comprises a clock and/or is in communication with a clock. In various embodiments, the processing elements of the controller 30 are configured to execute executable instructions compiled in accordance with quantum assembly (QASM) and/or another quantum intermediate representation (QIR) compilation process.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing element 705) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 705). In various embodiments, the driver controller elements 715 may enable the controller 30 to operate a manipulation source 60 to provide an input optical beam, voltage sources 80 to provide respective electrical control signals to respective control electrodes 214, any electromagnets of the magnetic field gradient source 70, and/or the like. In various embodiments, the driver controller elements 715 enable the controller 30 to control and/or operate various drivers (e.g., laser drivers; vacuum component drivers; cryogenic and/or vacuum system component drivers; and/or the like).

In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 725 configured to receive signals from one or more optical receiver components, calibration sensors, and/or the like.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

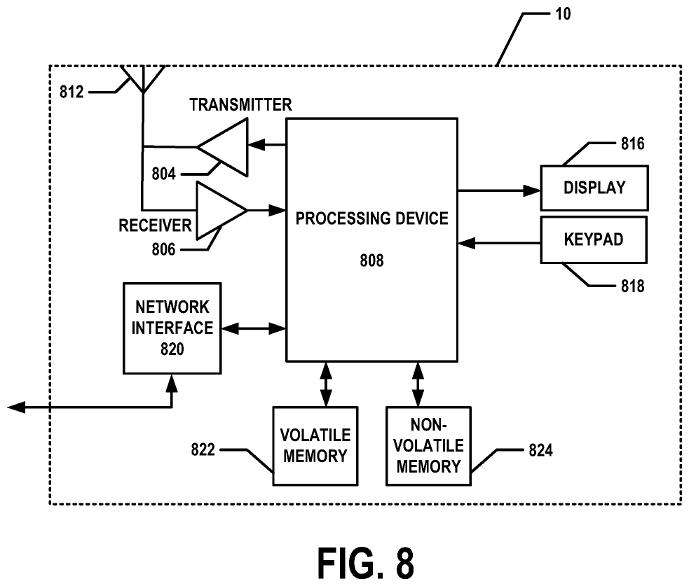

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing element 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. In various embodiments, the computing entity 10 comprises a network interface 820 configured to enable communication between the computing entity 10 and the controller 30 and/or various other computing apparatuses. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 816 and/or speaker/speaker driver coupled to a processing element 808 and a touch screen, keyboard, mouse, and/or microphone coupled to a processing element 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for performing a geometric phase gate, the method comprising:
controlling, by a controller, operation of a confinement apparatus to cause two or more quantum objects confined by the confinement apparatus and disposed in a magnetic field gradient zone of the confinement apparatus to experience a magnetic field gradient; and
responsive to determining that a gate time period has elapsed with at least one of (a) the two or more quantum objects disposed within the magnetic field gradient zone or (b) the two or more quantum objects experiencing the magnetic field gradient, controlling, by the controller, operation of the confinement apparatus to cause the two or more quantum objects to stop experiencing the magnetic field gradient.

2. The method of claim 1, wherein the two or more quantum objects are entangled within the magnetic field gradient zone during the gate time period without use of any radiating fields to mediate entanglement of the two or more quantum objects.

3. The method of claim 1, wherein the magnetic field gradient mediates entanglement of the two or more quantum objects within the magnetic field gradient zone.

4. The method of claim 3, wherein the gate time period is determined based at least in part on an amount of time it takes for the magnetic field gradient to mediate the entanglement of the two or more quantum objects.

5. The method of claim 1, further comprising causing respective quantum states of the two or more quantum objects to be evolved to respective gate subspace states.

6. The method of claim 5, wherein the respective quantum states are evolved out of a memory subspace and into a gate subspace, wherein the respective gate subspace states are respective states of the gate subspace.

7. The method of claim 6, wherein the memory subspace comprises two or more memory states that are each a respective clock state and the gate subspace comprises two or more gate subspace states that are each Zeeman states.

8. The method of claim 5, wherein evolving the respective quantum states to the respective gate subspace states comprises causing a manipulation signal characterized by a frequency that is substantially resonant with the frequency difference between at least one memory subspace state and a corresponding gate subspace state to be incident on at least one of the two or more quantum objects.

9. The method of claim 5, wherein causing the two or more quantum objects to stop experiencing the magnetic field gradient comprises:
evolving the respective quantum states of the two or more quantum objects from the gate subspace to respective memory states.

10. The method of claim 9, wherein evolving the respective quantum states of the two or more quantum objects from the gate subspace to respective memory states comprises causing a manipulation signal characterized by a frequency that is substantially resonant with the frequency difference between at least one memory subspace state and a corresponding gate subspace state to be incident on at least one of the two or more quantum objects.

11. The method of claim 1, further comprising, performing one or more dynamic decoupling sequences on at least one quantum object of the two or more quantum objects between an initiation of the gate time period and a completion of the gate time period.

12. The method of claim 11, wherein performing the one or more dynamic decoupling sequences on the at least one quantum objects of the two or more quantum objects comprises causing a dynamic decoupling manipulation signal to be incident on the at least one quantum object.

13. The method of claim 1, wherein:
the magnetic field gradient is turned on in the magnetic field gradient zone at least one of (a) while the two or more quantum objects are being transported into the magnetic field gradient zone or (b) while the two or more quantum objects are disposed within the magnetic field gradient zone, and
the magnetic field gradient is turned off in the magnetic field gradient zone at least one of (a) while the two or more quantum objects are being transported out of the magnetic field gradient zone, (b) while the two or more quantum objects are disposed within the magnetic field gradient zone, or (c) after the two or more quantum objects are transported out of the magnetic field gradient zone.

14. The method of claim 1, wherein one of (a) the magnetic field gradient is a static magnetic field gradient and is substantially constant over the gate time period or (b) the magnetic field gradient oscillates during the gate time period with a frequency that is less than a motional mode frequency of a motional mode of a respective quantum object of the two or more quantum objects.

15. A system configured for performing a geometric phase gate, the system comprising:
a confinement apparatus defining at least one magnetic field gradient zone and operable to confine two or more quantum objects; and
a controller configured to control operation of the confinement apparatus, the controller configured to:
control operation of the confinement apparatus to cause the two or more quantum objects confined by the confinement apparatus within the at least one magnetic field gradient zone of the confinement apparatus to experience a magnetic field gradient; and
responsive to determining that a gate time period has elapsed with at least one of (a) the two or more quantum objects disposed within the magnetic field gradient zone or (b) the two or more quantum objects experiencing the magnetic field gradient, control operation of the confinement apparatus to cause the two or more quantum objects to stop experiencing the at least one magnetic field gradient.

16. The system of claim 15, wherein the confinement apparatus comprises or is associated with at least one of (a) at least one permanent magnet or (b) at least one electromagnet configured to cause the magnetic field gradient to be present in the at least one magnetic field gradient zone.

17. The system of claim 15, wherein the confinement apparatus defines a plurality of magnetic field gradient zones, comprising the at least one magnetic field gradient zone, and the two or more quantum objects comprise a plurality of pairs of quantum objects and the controller is configured to cause each of the plurality of pairs of quantum objects to be transported into and out of respective magnetic field gradient zones of the plurality of magnetic field gradient zones substantially simultaneously.

18. The system of claim 15, wherein the confinement apparatus defines at least one radiating field zone that is spatially distinct from the at least one magnetic field gradient zone and the controller is further configured to, prior to causing transportation of the two or more quantum objects into the at least one magnetic field gradient zone, causing a respective quantum states of at least one quantum object of the two or more quantum objects to be evolved to a respective gate subspace state while the at least one quantum object is disposed within the at least one radiating field zone.

19. A method for performing a geometric phase gate, the method comprising:
causing, by a controller of a quantum system, two or more qubits of the quantum system to experience a magnetic field gradient; and
responsive to determining that a gate time period has elapsed since the two or more qubits of the quantum system started to experience the magnetic field gradient, causing, by the controller, the two or more qubits to no longer experience the magnetic field gradient.

20. The method of claim 19, wherein the gate time period is determined based at least in part on an amount of time it takes for the magnetic field gradient to mediate the entanglement of the two or more qubits.
